(19) United States
(12) Patent Application Publication
(10) Pub. No.: US 2006/0053438 A1
(43) Pub. Date: Mar. 9, 2006

(54) Signal processing device and method of controlling the same

(75) Inventor: Akira Miyazawa, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/215,002

(22) Filed: Aug. 31, 2005

(30) Foreign Application Priority Data
Sep. 3, 2004 (JP) 2004-257039

(51) Int. Cl. H04N 7/16; H04N 7/173

(52) U.S. Cl. 725/25; 725/100; 725/131

(57) ABSTRACT

A signal processing device comprises a trigger detecting means configured to detect that a predetermined trigger for registering a digital recording device connected to a network has been provided, a device search means configured to make a search for the digital recording device connected to the network via a connection means when the trigger detecting means detects that the predetermined trigger has been provided, and a device register means configured to register the digital recording device searched by the device search means.

### CROSS-REFERENCE TO RELATED APPLICATIONS

This application is based upon and claims the benefit of priority from prior Japanese Patent Application No. 2004-257039, filed Sep. 3, 2004, the entire contents of which are incorporated herein by reference.

### BACKGROUND OF THE INVENTION

1. Field of the Invention

The present invention relates to a signal processing device which restores a picture signal, a voice signal and the like from an input signal, and a method of controlling the signal processing device. More particularly, the present invention relates to an improvement of a signal processing device and a method of controlling the signal processing device capable of making control by connecting a recording device to an external unit.

2. Description of the Related Art

As is well known, in recent years, the digitization of a television broadcast has been accelerated. For example, in Japan, there has been started a terrestrial digital broadcast as well as a satellite digital broadcast such as a BS (broadcasting satellite) digital broadcast and a 110-degree CS (communication satellite) digital broadcast.

In addition, in a digital broadcast receiver for receiving such a digital television broadcast, it becomes possible to digitally record a received program or reproduce a recorded program by connecting a digital recording device having a high capacity such as, for example, an HDD (hard disk driver).

Further, currently, a plurality of digital recording devices are networked by connecting them to one digital broadcast receiver, whereby the digital broadcast receiver can specify an arbitrary digital recording device to cause the recording device to carry out program recording or can specify an arbitrary digital recording device to cause the recording device to carry out program reproduction.

In the meantime, in such a digital broadcast receiver capable of connecting a plurality of digital recording devices via a network, it is important for a user to freely utilize the digital recording devices connected via a network by easily registering them without carrying out any complicated operation.

In Jpn. Pat. Appln. KOKAI Publication No. 2004-126963, there is disclosed an information processing apparatus such that a microprocessor mounted on a channel adapter 40, 41 and a disk adapter 60, 61 makes an initial setting operation by turning ON power, and a method of setting the apparatus.

In addition, in Jpn. Pat. Appln. KOKAI Publication No. 2003-91449, there is disclosed a storage system and a method of managing the storage system in the case where a storage device for storing data contained in the storage system can be used from another device.

### BRIEF SUMMARY OF THE INVENTION

According to one aspect of the present invention, there is provided a signal processing device comprising: a connection means configured to make connection to a network; a trigger detecting means configured to detect that a predetermined trigger for registering a digital recording device connected to the network has been provided; a device search means configured to make a search for the digital recording device connected to the network via the connection means when the trigger detecting means detects that the predetermined trigger has been provided; a device register means configured to register the digital recording device searched by the device search means; and a control means configured to cause the digital recording device registered by the device register means to carry out recording or reproduction.

According to another aspect of the present invention, there is provided a signal processing device control method comprising: a first step of connecting a signal processing device to a network via a connection means; a second step of detecting that a predetermined trigger for registering a digital recording device connected to the network has been provided; a third step of making a search for the digital recording device connected to the network via the connection means when the predetermined trigger is detected; a fourth step of registering the searched digital recording device; and a fifth step of causing the registered digital recording device to carry out recording or reproduction.

### BRIEF DESCRIPTION OF THE SEVERAL VIEWS OF THE DRAWING

FIG. 1 is a diagram showing one embodiment of the present invention, the diagram schematically illustrating an example of a digital television broadcast receiver and a network system configured around the receiver;

FIG. 2 is a block diagram for explaining essential signal processing systems of the digital television broadcast receiver in the embodiment;

FIG. 3 is an external view for explaining a remote controller of the digital television broadcast receiver in the embodiment;

FIG. 4 is a flow chart for explaining an operation for automatically registering a NAS connected to a LAN by the digital television broadcast receiver in the embodiment;

FIG. 5 is a flow chart for explaining an operation for automatically registering a NAS connected to a NAS exclusive port of the LAN by the digital television broadcast receiver in the embodiment;

FIG. 6 is a view for explaining an example of a directory structure in the NAS of the embodiment;

FIG. 7 is a flow chart for explaining an operation for automatically registering a shared folder of the NAS connected to the LAN the digital television broadcast receiver in the embodiment; and

FIG. 8 is a flow chart for explaining an operation for automatically registering a shared folder of the NAS connected to the NAS exclusive port of the LAN by the digital television broadcast receiver in the embodiment.

### DETAILED DESCRIPTION OF THE INVENTION

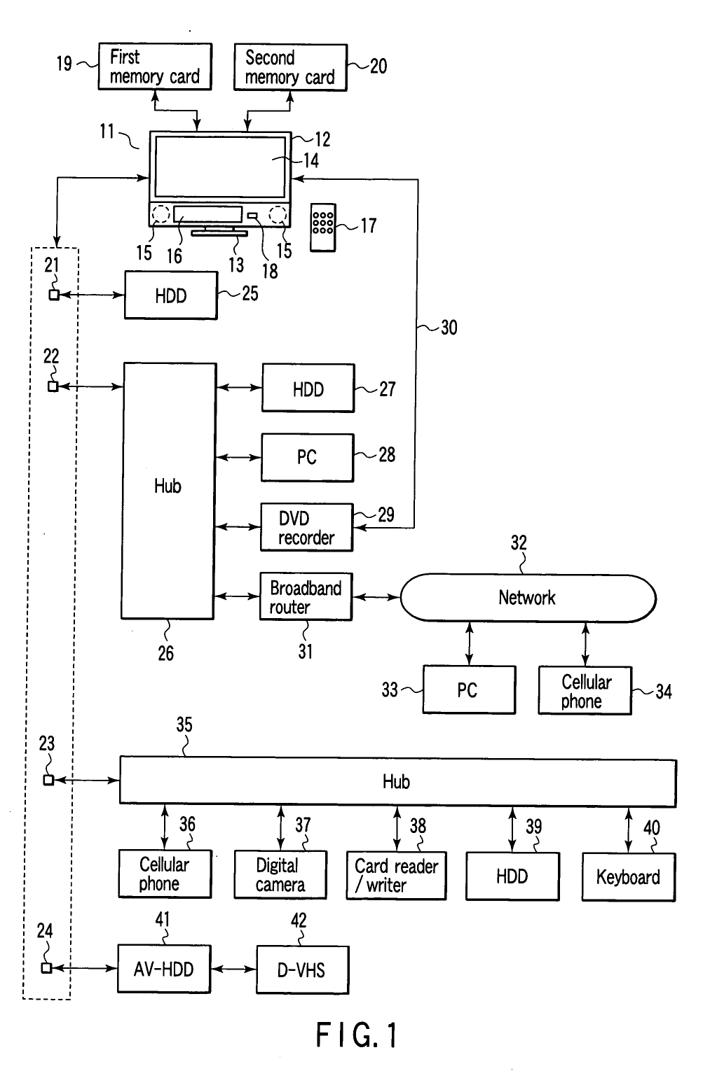

Hereinafter, one embodiment of the present invention will be described with reference to the accompanying drawings. FIG. 1 schematically shows an appearance of a digital television broadcast receiver 11 explained in the embodiment and an example of a network system configured around the digital television broadcast receiver 11.

That is, the digital television broadcast receiver 11 is essentially composed of a thin cabinet 12 and a support base 13 for supporting the cabinet 12 in an erected manner. On the cabinet 12, a flat panel type picture display device 14 composed of, for example, a liquid crystal display panel, a speaker 15, an operating unit 16, and a light receiving unit 18 for receiving operational information from a remote controller 17 are installed.

In addition, a first memory card 19 such as a secure digital (SD) memory card, a multimedia card (MMC), and a memory stick can be removably mounted on the digital television broadcast receiver 11. Information such as a program or a photograph is recorded in or reproduced from the first memory card 19.

Further, a second memory card (IC card) 20 having, for example, contract information or the like recorded therein can be removably mounted on the digital television broadcast receiver 11. Information is recorded in or reproduced from the second memory card 20.

Furthermore, the digital television broadcast receiver 11 comprises a first local area network (LAN) terminal 21, a second LAN terminal 22, a universal serial bus (USB) terminal 23, and an i.Link terminal 24.

Among them, the first LAN terminal 21 is used as a LAN compatible HDD exclusive port. This first LAN terminal is used to record and reproduce information in and from a LAN compatible HDD 25 which is a connected network attached storage (NAS) via the Ethernet (registered trademark).

In this way, the first LAN terminal 21 is provided as a LAN compatible HDD exclusive port, whereby information of a high vision image quality program can be stably recorded in the HDD 25 without being affected by another network environment, a network use status and the like.

Further, the second LAN terminal 22 is used as a general LAN compatible port using the Ethernet. For example, this second LAN terminal is used to connect devices such as a LAN compatible HDD 27, a personal computer (PC) 28, and an HDD built-in digital versatile disk (DVD) recorder 29 via a hub 26, and transmit information to these devices.

With respect to the DVD recorder 29, digital information communicated via the second LAN terminal 22 is information oriented to only a control system. Therefore, there is a need for providing a dedicated analog transmission channel 30 in order to transmit an analog picture and voice information between the LAN terminal and the digital television broadcast receiver 11.

Furthermore, the second LAN terminal 22 is used to make connection to a network 32 such as, for example, the Internet via a broadband router 31 connected to the hub 26 and transmit information to a PC 33, a cellular phone 34 and the like via the network 32.

In addition, the above-described USB terminal 23 is used as a general USB compatible port. For example, this USB terminal is used to connect USB devices such as a cellular phone 36, a digital camera 37, a card reader/writer 38 compatible with a memory card, an HDD 39, and a keyboard 40 via a hub 35, and transmit information to these USB devices.

Further, the above-described i.Link terminal 24 is used to serially connect, for example, an AV-HDD 41, a D (digital)-VHS (video home system) 42 and the like, and transmit information to these devices.

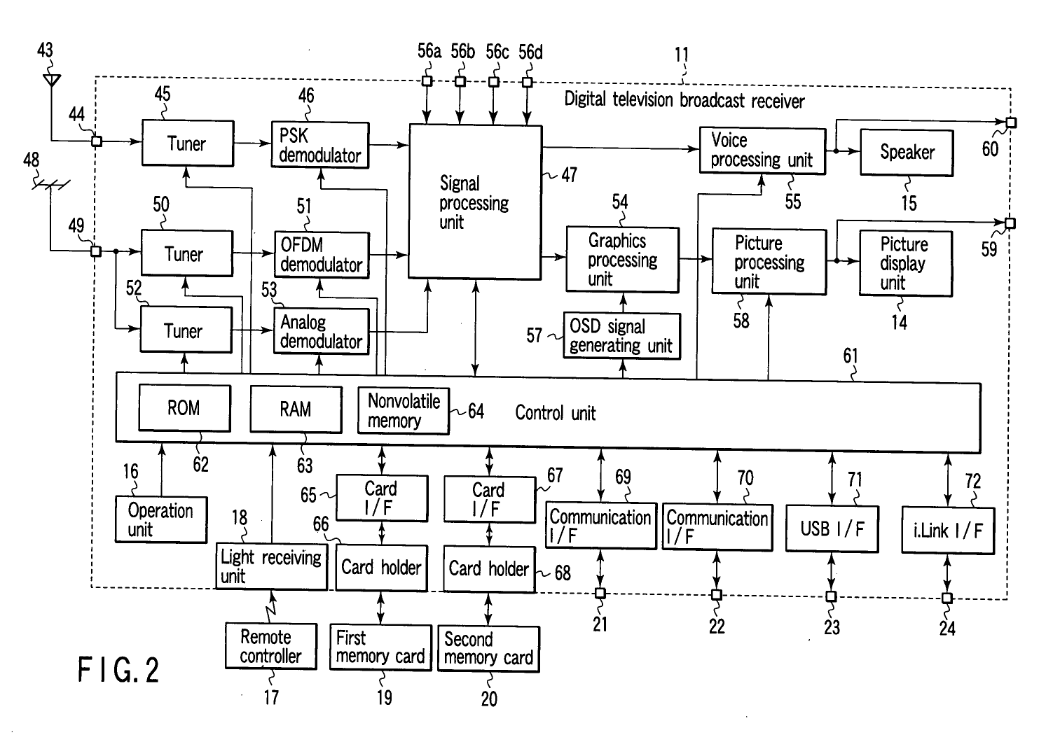

FIG. 2 shows essential signal processor systems of the above-described digital television receiver 11. That is, a satellite digital television broadcast signal received by a BS/CS digital broadcast receiving antenna 43 is supplied to a satellite digital broadcast tuner 45 via an input terminal 44, whereby a broadcast signal of a desired channel is channel-selected.

Then, the broadcast signal which has been channel-selected by the tuner 45 is supplied to a phase shift keying (PSK) demodulator 46, the supplied signal is demodulated to a digital picture signal and a voice signal, and then, the demodulated signals are outputted to a signal processing unit 47.

In addition, a terrestrial digital television broadcast signal received by a terrestrial broadcast receiving antenna 48 is supplied to a terrestrial digital broadcast tuner 50 via an input terminal 49, whereby a broadcast signal of a desired channel is channel-selected.

Then, the broadcast signal which has been channel-selected by the tuner 50 is supplied to an orthogonal frequency division multiplexing (OFDM) demodulator 51, the supplied signal is demodulated to a digital picture signal and a voice signal, and then, the demodulated signals are outputted to the signal processing unit 47.

A terrestrial analog television broadcast signal received by the terrestrial broadcast receiving antenna 48 is supplied to a terrestrial analog broadcast tuber 52 via an input terminal 49, whereby a broadcast signal of a desired channel is channel-selected. Then, the broadcast signal which has been channel-selected by the tuner 52 is supplied to an analog demodulator 53, the supplied signal is demodulated to an analog picture signal and a voice signal, and then, the demodulated signals are outputted to the signal processing unit 47.

Here, the above signal processing unit 47 selectively applies predetermined digital signal processing to the digital picture signal and voice signal supplied from the PSK demodulator 46 and the OFDM demodulator 51, respectively, and outputs the signals to a graphic processing unit 54 and a voice processing unit 55.

A plurality of input terminals 56a, 56b, 56c, 56d (four terminals as illustrated) are connected to the signal processing unit 47. These input terminals 56a to 56d each can input an analog picture signal and an analog voice signal from an external unit of the digital television broadcast receiver 11.

Then, the signal processing unit 47 selectively digitizes the analog picture signal and voice signal supplied from the analog demodulator 53 and each of the input terminals 56a to 56d, respectively. Predetermined digital processing is applied to the digitized picture signal and voice signal, and then, the resulting signals are outputted to the graphic processing unit 54 and the voice processing unit 55.

Among them, the graphic processing unit 54 has a function of superimposing and outputting an OSD signal generated by an OSD (on screen display) signal generating unit 57 to the digital picture signal supplied from the signal processing unit 47. The graphic processing unit 54 can selectively output the output picture signal of the signal processing unit 47 and the output OSD signal of the OSD signal generating unit 57, and can provide both outputs in combination so as to configure half of a screen, respectively.

Then, the digital picture signal outputted from the graphic processing unit 54 is supplied to a picture processing unit 58. The picture processing unit 58 converts the inputted digital picture signal to an analog picture signal in a format which can be displayed on the picture display device 14. Then, the converted signal is outputted to the picture display device 14 so as to be displayed as a picture and to be led out to the outside via an output terminal 59.

The above voice processing unit 55 converts the inputted digital voice signal to an analog voice signal in a format which can be reproduced by the speaker 15. Then, the converted signal is outputted to the speaker 15 so as to be reproduced as a voice and to be led out to the outside via an output terminal 60.

Here, in the digital television broadcast receiver 11, all the related operations including the above-described various receiving operations are integrally controlled by a control unit 61. The control unit 61 incorporates a central processing unit (CPU) and the like, receives operational information from the operating unit 16 or receives operational information sent out from the remote controller 17, and controls each unit such that its operational content is reflected.

In this case, the control unit 61 mainly utilizes a read only memory (ROM) 62 having stored therein a control program executed by a CPU thereof, a random access memory (RAM) 63 which provides a work area to the CPU, and a nonvolatile memory 64 having stored therein a variety of setting information and control information.

The control unit 61 is connected to a card holder 66 on which the first memory card 19 can be mounted, via a card interface (I/F) 65. In this manner, the control unit 61 can transmit information to the first memory card 19 mounted on the card holder 66 via the card I/F 65.

Further, the control unit 61 is connected to a card holder 68 on which the second memory card 20 can be mounted, via a card I/F 67. In this manner, the control unit 61 can transmit information to the second memory card 20 mounted on the card holder 68 via the card I/F 67.

The control unit 61 is also connected to the first LAN terminal 21 via a communication I/F 69. In this manner, the control unit 61 can transmit information to the LAN compatible HDD 25 connected to the first LAN terminal 21 via the communication I/F 69. In this case, the control unit 61 has a dynamic host configuration protocol (DHCP) server function and assigns an Internet protocol (IP) address to the LAN compatible HDD 25 connected to the first LAN terminal 21 to make control.

The control unit 61 is connected to the second LAN terminal 22 via a communication I/F 70. In this manner, the control unit 61 can transmit information to each device (refer to FIG. 1) connected to the second LAN terminal 22 via the communication I/F 70.

Further, the control unit 61 is connected to the USB terminal 23 via a USB I/F 71. In this manner, the control unit 61 can transmit information to each device (refer to FIG. 1) connected to the USB terminal 23 via the USB I/F 71.

Moreover, the control unit 61 is connected to the i.Link terminal 24 via an i.Link I/F 72. In this manner, the control unit 61 can transmit information to each device (refer to FIG. 1) connected to the i.Link terminal 24 via an i.Link I/F 72.

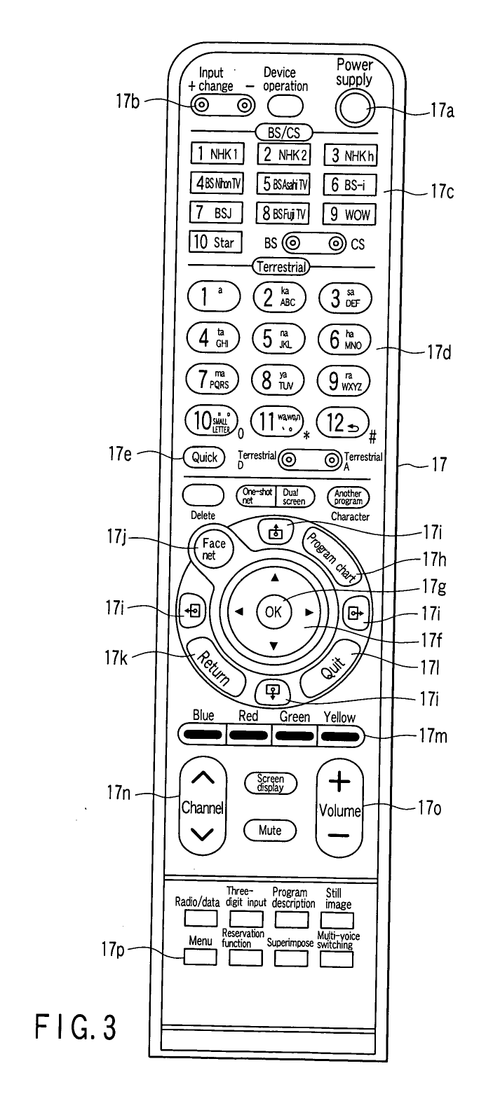

FIG. 3 shows an appearance of the above-described remote controller 17. The remote controller 17 is mainly provided with a power supply key 17a, an input change key 17b, a satellite digital broadcast channel direct channel-selector key 17c, a terrestrial broadcast channel direct channel-selector key 17d, a quick key 17e, cursor keys 17f, an OK key 17g, a program chart key 16h, page change keys 17i, a face net (navigation) key 17j, a return key 17k, an exit key 17l, blue, red, green, and yellow color keys 17m, channel up and down keys 17n, a volume control key 17o, a menu key 17p, and the like.

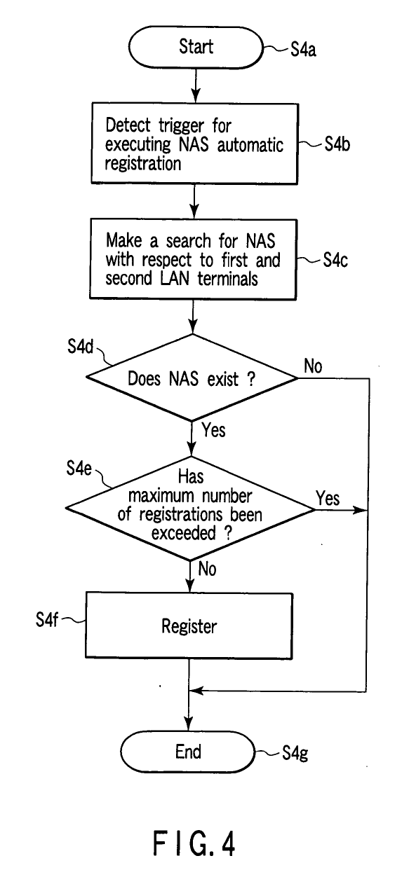

FIG. 4 shows a flow chart for explaining an operation in which the digital television broadcast receiver 11 automatically makes a search for, and registers, a NAS (the HDD 25, 27 in the case of FIG. 1) which is a network connection type digital recording device connected to the first and second LAN terminals 21, 22.

When the operation is started (step S4a), the control unit 61 detects that a predetermined trigger for executing NAS automatic registration has been provided in step S4b. A predetermined trigger provided to execute NAS automatic registration includes, for example, turning ON the power supply of the digital television broadcast receiver 11 (operating the power supply key 17a of the remote controller 17); starting up a set menu for registering the NAS; and making a request for executing a reproducing operation or a recording operation from or in the NAS connected to the first and second LAN terminals 21, 22.

After a search has been made for the NAS with respect to the first and second LAN terminals 21, 22 in step S4c, the control unit 61 determines whether or not the NAS exists in step S4d. In the case where the determination result is negative (NO), the control unit 61 terminates processing (step S4g).

In addition, in the case where the determination result is affirmative in step S4d (YES), the control unit 61 determines whether or not a maximum number of registrations has been exceeded in step S4e. In the case where the determination result is affirmative (YES), the control unit terminates processing (step S4g).

On the other hand, in the case where the determination result is negative in step S4e (NO), the control unit 61 registers the NAS whose presence has been detected in the nonvolatile memory 64 in step S4f, and terminates processing (step S4g).

According to this operation, when a predetermined trigger for executing NAS automatic registration has been provided, a search is automatically made for the NAS with respect to the first and second LAN terminals 21, 22. In the case where the NAS exists, registration is carried out. Thus, there is no need for a user to open a set menu and to make a search for and register the NAS over a network, thereby making it possible to reduce the user setting.

Then, for the thus registered NAS, the digital television broadcast receiver 11 can make control so as to record a received television broadcast program or a digital picture signal (photograph) encoded in a mode which conforms to the JPEG (joint photographic exparts group) standard, the signal being stored in the first memory card 19, the digital camera 37 and the like.

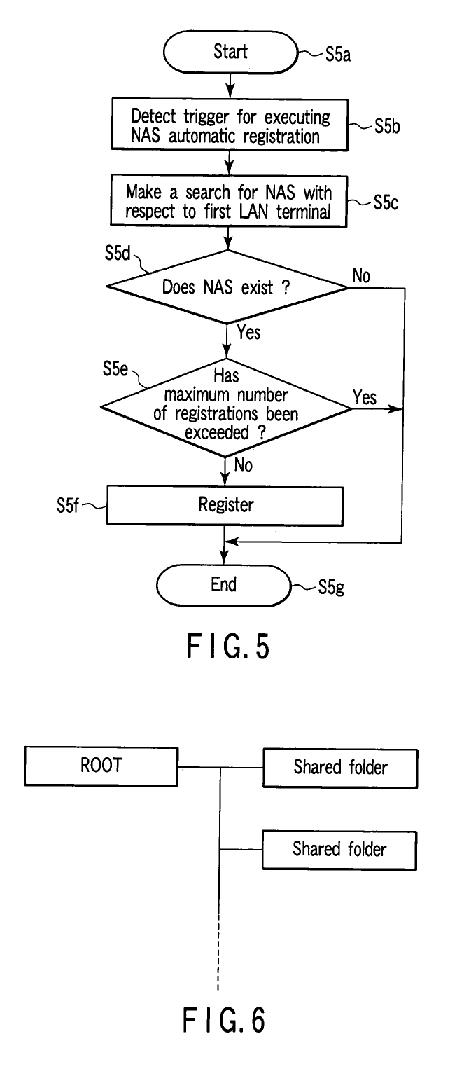

FIG. 5 shows a flow chart for explaining an operation in which the digital television broadcast receiver 11 automatically registers a NAS (the HHD 25 in the case of FIG. 1) connected to the first LAN terminal 21. (In the digital television broadcast receiver 11 explained in the embodiment, although the first LAN terminal is used as an HDD exclusive port, it may be used as a NAS exclusive port to which only the NAS is connected.)

When this operation is started (step S5a), the control unit 61 detects that a predetermined trigger for executing NAS automatic registration has been provided in step S5b. A predetermined trigger provided to execute NAS automatic registration includes, for example, turning ON power supply of the digital television broadcast receiver 11 (operating the power supply key 17a of the remote controller 17); starting up a set menu for registering the NAS; and making a request for executing a reproducing operation or a recording operation from or in the NAS connected to the first LAN terminal 21 (NAS exclusive port).

After a search has been made for the NAS with respect to the first LAN terminal 21 in step S5c, the control unit 61 determines whether or not the NAS exists in step S5d. In the case where the determination result is negative (NO), the control unit terminates processing (step S5g).

In the case where the determination result is affirmative (YES), the control unit 61 determines whether or not a maximum number of registrations has been exceeded in step S5e. In the case where the determination result is affirmative (YES), the control unit terminates processing (step S5g).

On the other hand, in the case where the determination result is negative in step S5e (NO), the control unit 61 registers the NAS whose presence has been detected in the nonvolatile memory 64 in step S5f. Then, this control unit terminates processing (step S5g).

According to this operation, when a predetermined trigger for executing NAS automatic registration has been provided, a search is automatically made for the NAS with respect to the first LAN terminal 21. In the case where the NAS exists, registration is carried out. Thus, there is no need for the user to open the set menu and to make a search for and register the NAS over a network, thereby making it possible to reduce the user setting.

FIG. 6 shows an example of a directory structure in the NAS. The directory structure is formed in a hierarchical shape, and a plurality of shared folders (two folders as illustrated) are produced under a root directory (ROOT) which resides at the highest order of the hierarchy.

In this case, there are two different types of shared folders, i.e., a shared folder for a guest user which is available to an unspecified number of users via a network and a shared folder which can be used by only a user who has inputted a password.

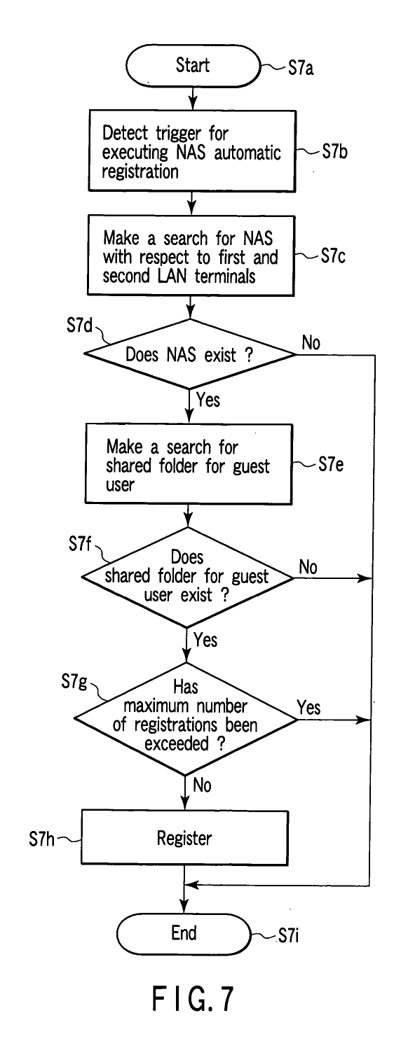

FIG. 7 shows a flow chart for explaining an operation for, in the case where a shared folder for a guest user exists in a searched NAS when the NAS connected to the first and second LAN terminals 21, 22 is automatically registered, automatically registering that shared folder.

When this operation is started (step S7a), the control unit 61 detects that a predetermined trigger for executing NAS automatic registration has been provided in step S7b. This trigger is identical to that described in the flow chart of FIG. 4.

After a search has been made for a NAS with respect to the first and second LAN terminals 21, 22 in step S7c, the control unit 61 determines whether or not the NAT exists in step S7d. In the case where the determination result is negative (NO), the control unit terminates processing (step S7i).

In addition, in the case where the determination result is affirmative in step S7d (YES), the control unit 61 makes a search for a shared folder for a guest user from the NAS whose existing has been detected in step S7e. Then, the control unit determines whether or not the shared folder NAS for the guest user exists in step S7f. In the case where the determination result is negative (NO), the control unit terminates processing (step S7i).

On the other hand, in the case where the shared folder NAS for the guest user exists in step S7f (YES), the control unit 61 determines whether or not a maximum number of registration has been exceeded in step S7g. In the case where the determination result is affirmative (YES), the control unit terminates processing (step S7i).

In the case where the determination result is negative (NO) in step S7g, the control unit 61 registers in the nonvolatile memory 61 the NAS whose presence has been detected and the shared folder for the guest user contained therein in step S7h. Then, the control unit terminates processing (step S7i).

According to this operation, the NAS and the shared folder for the guest user contained therein are automatically registered. Thus, the user of the digital television broadcast receiver 11 can record information in the NAS shared folder and manage the information, thus making it possible for the user to handle the information more conveniently.

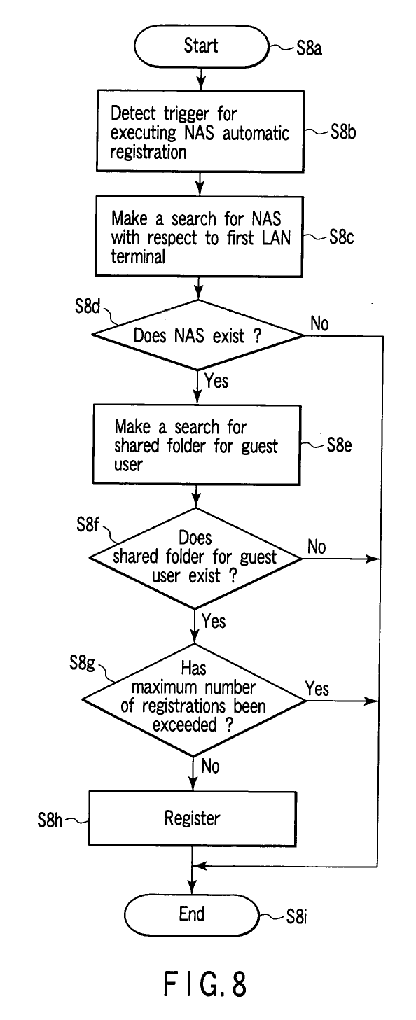

FIG. 8 shows a flow chart for explaining an operation for, in the case where a shared folder for a guest user exists in a searched NAS when a NAS connected to the first LAN terminal 21 (NAS exclusive port) is automatically registered, automatically registering the shared folder.

When this operation is started (in step S8a), the control unit 61 detects that a predetermined trigger for executing NAS automatic registration has been provided in step S8b. This trigger is identical to that described in the flow chart of FIG. 5.

After a search has been made for a NAS with respect to the first LAN terminal 21 in step S8c, the control unit 61 determines whether or not the NAS exists in step S8d. In the case where the determination result is negative (NO), the control unit terminates processing (step S8i).

In the case where the determination result is affirmative (YES), the control unit 61 makes a search for a shared folder for a guest user from the NAS whose existing has been detected in step S8d. Then, the control unit determines whether or not the shared folder NAS for the guest user exists in step S8f. In the case where the determination result is negative (NO), the control unit terminates processing (step S8i).

On the other hand, in the case where the shared folder NAS for the guest user exists in step S8f (YES), the control unit 61 determines whether or not a maximum number of registration has been exceeded in step S8g. In the case where the determination result is affirmative (YES), the control unit terminates processing (step S8i).

In the case where the determination result is negative (NO) in step S8g, the control unit 61 registers in the nonvolatile memory 61 the NAS whose presence has been detected and the shared folder for the guest user contained therein in step S8h. Then, the control unit terminates processing (step S8i).

According to this operation, the NAS and the shared folder for the guest user contained therein are automatically registered. Thus, the user of the digital television broadcast receiver 11 can record information in the NAS shared folder and manage the information, thus making it possible for the user to handle the information more conveniently.

The present invention is not limited to the above-described embodiments. The invention can be embodied by variously modifying constituent elements without departing from the spirit of the invention at a stage of carrying out the invention. In addition, a variety of inventions can be formed by properly combining a plurality of constituent elements disclosed in the above-described embodiments. For example, some of all the constituent elements presented in the embodiments may be erased. Further, constituent elements according to different embodiments may be properly combined with each other.

What is claimed is:

1. A signal processing device comprising:
a connection means configured to make connection to a network;
a trigger detecting means configured to detect that a predetermined trigger for registering a digital recording device connected to the network has been provided;
a device search means configured to make a search for the digital recording device connected to the network via the connection means when the trigger detecting means detects that the predetermined trigger has been provided;
a device register means configured to register the digital recording device searched by the device search means; and
a control means configured to cause the digital recording device registered by the device register means to carry out recording or reproduction.

2. A signal processing device according to claim 1, wherein the trigger detecting means is configured to detect as the trigger at least one of turning ON power, starting up a set menu for registering the digital recording device, and making a request for executing a reproducing operation or a recording operation for the digital recording device.

3. A signal processing device according to claim 2, wherein the connection means comprises:
a first connection terminal set in order to exclusively connect the digital recording device; and
a second connection terminal set to enable connection to a device other than the digital recording device.

4. A signal processing device according to claim 3, wherein the device search means is configured to make a search for the digital recording device with respect to the first and second connection terminals.

5. A signal processing device according to claim 3, wherein the device search means is configured to make a search for the digital recording device with respect to only the first connection terminal.

6. A signal processing device according to claim 1, further comprising a shared folder search means configured to make a search for a shared folder from the digital recording device searched by the device search means, wherein the device register means is configured to register the shared folder searched by the shared folder search means.

7. A signal processing device according to claim 6, wherein the shared folder search means is configured to make a search for a shared folder for a guest user.

8. A signal processing device according to claim 1, wherein the device register means is configured to enable registration up to a predetermined maximum number of registrations.

9. A signal processing device according to claim 1, wherein the digital recording device is a network connection type.

10. A signal processing device according to claim 1, wherein the digital recording device is a NAS.

11. A signal processing device control method comprising:
a first step of connecting a signal processing device to a network via a connection means;
a second step of detecting that a predetermined trigger for registering a digital recording device connected to the network has been provided;
a third step of making a search for the digital recording device connected to the network via the connection means when the predetermined trigger is detected;
a fourth step of registering the searched digital recording device; and
a fifth step of causing the registered digital recording device to carry out recording or reproduction.

12. A signal processing device control method according to claim 11, further comprising a sixth step of making a search for a shared folder from the digital recording device searched in the third step, wherein the fourth step registers the searched digital recording device and shared folder, and the fifth step causes the registered digital recording device to carry out recording or reproduction for a shared folder of the digital recording device.
